(19) United States
(12) Patent Application Publication
(10) Pub. No.: US 2014/0028450 A1
(43) Pub. Date: Jan. 30, 2014

(54) REMOTE CONTROL FOR PORTABLE ELECTRONIC DEVICES

(71) Applicant: Maria Murray, Sierra Madre, CA (US)

(72) Inventor: Maria Murray, Sierra Madre, CA (US)

(21) Appl. No.: 14/111,535

(22) PCT Filed: Apr. 12, 2012
(86) PCT No.: PCT/US12/33348

§ 371 Date: Oct. 11, 2013

Related U.S. Application Data
(60) Provisional application No. 61/474,605, filed on Apr. 12, 2011.

(51) Int. Cl. G08C 19/28

(52) U.S. Cl. CPC G08C 19/28
USPC 340/12.31; 340/12.22; 340/12.54; 340/12.5

(57) ABSTRACT

A system for remote control of a portable electronic device comprising one or more than one remote control, one or more than one portable electronic device operably connected to the remote control, one or more than one microcontroller connected to the one or more than one remote control and computer instructions operable on the microcontroller stored on a storage connected to the remote control for manipulating the portable electronic device.

### CROSS-REFERENCE TO RELATED APPLICATIONS

The present Application is a PCT Patent Application which claims the benefit of U.S. Provisional Patent Application 61/474,605, titled “Remote Control For Portable Electronic Devices,” filed Apr. 12, 2011; the contents of which are incorporated in this disclosure by reference in their entirety.

### FIELD OF THE INVENTION

The present invention relates to remote control devices, more specifically to a remote control for portable electronic devices that is simple operate and operable with a single hand.

### BACKGROUND

There are many remote controls for various consumer electronic devices; among these are dedicated remote controls and programmable portable electronic devices. Advantageously, dedicated remote controls can enable a user to control one, and in some cases, more than one specific consumer electronic device. However, there are a limited number on consumer electronic devices that can be controlled. Additionally, the vast majority of dedicated remote controls use infrared signaling to control the devices requiring a direct line of site between the remote control and the consumer electronic device. Programmable portable electronic devices, such as, for example, Apple® iPhone®, iTouch®, iPad®, Android® phones etc., can be programmed to act as remote controls for consumer electronic devices. However, these programmable portable electronic devices have complicated interfaces that must be viewed and require two hands to operate. Also, there are no remote control devices to control these programmable portable electronic devices. Therefore there is a need for a remote control for portable electronic devices that is simple operate and operable with a single hand.

### SUMMARY

The present invention overcomes the limitations of the prior art by providing a system for a remote control for a portable device that comprises one or more than one remote control wired or wirelessly connected to one or more than one portable electronic device operably, one or more than one microcontroller, and computer instructions operable on the microcontroller stored on a storage connected to the remote control for manipulating the portable electronic device.

The remote control device comprises a body, one or more than one button, one or more than one control mechanism, one or more than one microcontroller one or more than one communications controller and a battery. In one embodiment, the one or more than one button are an up button, a down button, a left button and right button. The control mechanism can be a track pad, a trackball, or a joystick. In a preferred embodiment the control mechanism is a track pad. The microcontroller as a storage comprising computer instructions operable to enable the remote control to manipulate various functions on the portable electronic device. In one embodiment the instructions provide for mouse like emulation to control various other applications on the portable electronic device.

There is also provided a method for using a remote control device comprising a) storing a software program in a storage on the portable electronic device; b) activating the software program; and c) manipulating the portable electronic device using the remote control and instructions from the software program. The software program can be activated by the remote control or when the remote control is connected by a wire to the portable electronic device.

Optionally, there's provided an indicator on the portable electronic device that displays confirmation that the system is operational and ready for use. Additionally, a user can alter the actions that each control on the remote control performs.

The instructions for the software program comprise: a) selecting a menu item by pressing down on a track pad; b) scrolling on the portable electronic device; c) dragging on the portable electronic device; d) highlighting a selection by double clicking the track pad; e) selecting, highlighting or both selecting and highlighting everything on the portable remote device by triple clicking on the track pad; and f) flipping back and forth between pages by swiping a finger over the track pad in left to right and right to left motions. The left button of the remote can activate instructions on the microcontroller to provide functions for jumping to a last page, go back detects, begin chapter detects, and flip multiple pages backwards detects. The right button of the remote can activate instructions on the microcontroller for volume down detects and zoom out detects. The up button of the remote can activate instructions on the microcontroller to provide functions for increasing the volume and zoom in detects. The down button of the remote can activate instructions on the microcontroller to provide functions for decreasing the volume and a zoom out functionality.

In another embodiment, the method further comprises instructions for mouse emulation media where the instructions convert the received notification of a button press by the user into a pattern of mouse key codes and the microcontroller instructs a Bluetooth module to transmit the pattern of mouse key codes either wired or wirelessly as serial data to the portable electronic device.

In yet another embodiment, the method comprises instructions for keyboard control for: a) converting a button press into a key code; b) sending the key code to a Bluetooth module; c) transmitting the key code as wireless serial data to a portable electronic device.

In another embodiment the method further comprises instructions for mouse cursor control for: a) sending track pad commands to a microcontroller; b) converting the track pad commands into mouse key code; and c) transmitting the mouse key codes via a Bluetooth module as wireless serial data to a portable electronic device.

In another embodiment, the method further comprising instructions for mouse cursor control for: a) transmitting track pad position related data to the microcontroller; b) converting the track pad position data into mouse key codes; and c) transmitting the mouse key codes via a Bluetooth module as wireless serial data to a portable electronic device; where the motion of the cursor across the screen of the portable electronic device is relative to the motion across the track pad.

There is also provide a method for microcontroller software to control a portable electronic device comprising the steps of: a) detecting a motion sensor action; b) classifying the motion sensor action; c) generating a hexadecimal code pattern to match the classified action; and d) transmitting the generated hexadecimal code pattern to a Bluetooth module to be retransmitted to a portable electronic device. The motion sensor action can be classified as a macro action, a mouse action or both a macro action and a mouse action.

### BRIEF DESCRIPTION OF THE DRAWINGS

These and other features, aspects and advantages of the present invention will become better understood with regard to the following description, appended claims, and accompanying figures where:

FIG. 1 is a diagram of a system for a remote control for portable electronic devices that is simple operate and operable with a single hand according to one embodiment;

FIG. 2 is a is a detailed diagram of the remote control for portable electronic device of FIG. 1;

FIG. 3 is a diagram depicting a bottom view of the remote control of FIG. 1;

FIG. 4 is a diagram depicting a side view of the remote control of FIG. 1;

FIG. 5 is a diagram depicting an oblique and side view of the remote control of FIG. 1;

FIG. 6 is a functional diagram for using the remote control of FIG. 1;

FIG. 7 is a functional diagram for using a left button of the remote control of FIG. 1;

FIG. 8 is a functional diagram for using a right button of the remote control of FIG. 1;

FIG. 9 is functional diagram for using an up button of the remote control of FIG. 1;

FIG. 10 is a functional diagram for using a right button of the remote control of FIG. 1;

FIG. 11 is a flowchart of some steps of a method for an application, useful for operating the remote control of FIG. 1;

FIG. 12 is a flowchart of some steps of a method for mouse emulation media mode;

FIG. 13 is a flowchart of some steps of a method for simple keyboard control;

FIG. 14 is a flowchart of some steps of a method for mouse cursor control; and

FIG. 15 is a flowchart of some steps of a method for microcontroller software.

### DETAILED DESCRIPTION

The present invention overcomes the limitations of the prior art by providing a remote control 102 for portable electronic devices that is simple operate and operable with a single hand. As can be appreciated, currently available portable consumer electronic devices available today are more akin to computers than to simple, single function devices previously available. These devices are capable of storing, recalling, transmitting, receiving and displaying a vast array of file types. These devices are also capable of running multiple applications at the same time. However, as the complexity of the devices increase, so to, does the amount of interaction that is needed by the user to operate these devices. For example, a Kindle® eBook reader can only be operated by the user with a single hand for a short period of time as the position necessary to view the Kindle® comfortably is limited. Also, the user must always touch some portion of the Kindle® in order to operate the device, limiting the functionality to any infirmed user with limited mobility. Also, for example, an Apple® iPhone® is capable of displaying sales presentations with the appropriate hardware and software attachments making it a good solution for portable sales. However, the user must always have the iPhone® in their hand to move between slides or other documents. The present invention provides a system and method allowing the user greater freedom from the portable electronic device 104 while still being able to interact with the portable electronic device 104. As can be appreciated, there are many situations where a remote control 102 for portable electronic devices would be not only advantageous, but in some cases a necessity.

Methods and devices that implement the embodiments of the various features of the invention will now be described with reference to the drawings. The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element first appears.

As used in this disclosure, except where the context requires otherwise, the term “comprise” and variations of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific detail. Well-known circuits, structures and techniques may not be shown in detail in order not to obscure the embodiments. For example, circuits may be shown in block diagrams in order not to obscure the embodiments in unnecessary detail.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, a storage may represent one or more devices for storing data, including read-only memory (ROM), random access memory (RAM), magnetic disk storage mediums, optical storage mediums, flash memory devices and/or other machine readable mediums for storing information. The term “machine readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, or a combination thereof. When implemented in software, firmware, middleware or microcode, the program code or code segments to perform the necessary tasks may be stored in a machine-readable medium such as a storage medium or other storage(s). One or more than one processor may perform the necessary tasks in series, concurrently or in parallel. A code segment may represent a procedure, a function, a subprogram, a program, a routine, a subroutine, a module, a software package, a class, or a combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted through a suitable means including memory sharing, message passing, token passing, network transmission, etc.

In the following description, certain terminology is used to describe certain features of one or more embodiments of the invention.

The term “portable electronic device” refers to any current or future electronic device 104 such as a smartphone, a table, an eBook reader or the like that displays information to one or more than one user.

Various embodiments provide a device and a method for a remote control 102 for portable electronic devices that is simple operate and operable with a single hand. One embodiment of the present invention provides a system comprising one or more portable electronic device 104 and one or more remote control 102 for portable electronic devices. In another embodiment, there is provided a method for using the system. The system and method will now be disclosed in detail.

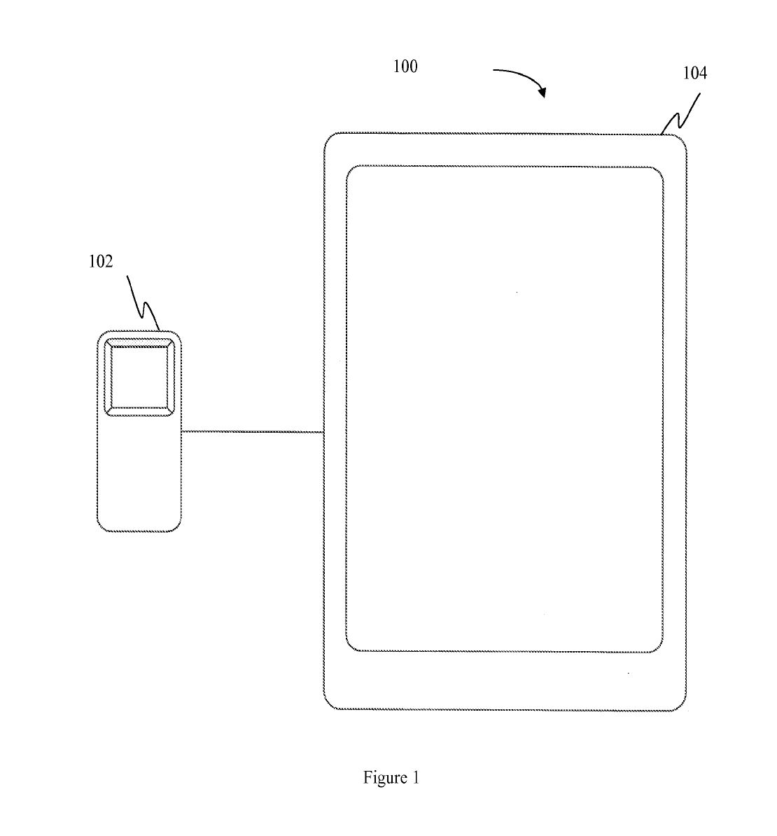

Referring now to FIG. 1, there is shown a diagram of a system 100 for a remote control 102 for portable electronic devices that is simple operate and operable with a single hand according to one embodiment. As can be seen, the system comprises a remote control 102 and a portable consumer electronic device 104. The remote control 102 is operably connected to the portable electronic device 104 wirelessly, wired or both wirelessly and wired. The connection between the remote control 102 and the portable electronic device 104 will depend upon the capabilities of the hardware and software of the portable electronic device 104.

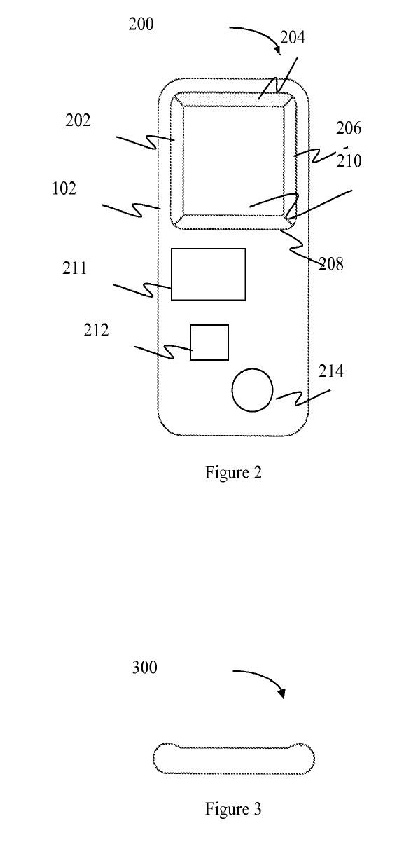

Referring now to FIG. 2, there is shown a detailed diagram 200 of the remote control 102 for portable electronic device 104 of FIG. 1. As can be seen, the remote control 102 can be small enough for a user to operate with a single hand. However, the remote control 102 can be larger to provide additional functionality and controls depending upon the needs of the user and the complexity of the portable device 104. In this embodiment, the remote control 102 comprises a track pad 210, an up button 204, a down button 208, a left button 202 and right button 206. Each of the buttons 202-208 and the track pad 210 can be assigned various functionality.

Additionally, the remote control 102 comprises one or more than one microcontroller 211 is disposed within the body of the remote control 102. One or more than one communication controller 212 is disposed within the body of the remote control 102 and operably connected to the one or more than one microcontrollers 211 for transmitting information from the remote control 1022 portable electronic device 104. A battery 214 to power the remote control 102 is also disposed within the body and electrically connected to all the components of the remote control 102.

As can be appreciated, other buttons or controls can be added or removed in other versions of the remote control 102. Accompanying software, not shown, is loaded into the portable electronic device 104 operable to enable the remote control 102 to manipulate various functions on the portable electronic device 104. In one embodiment, the application provides for mouse like emulation to control various other applications on the portable electronic device 104. For example, if the remote control 102 were connected to a Kindle®, the remote control 102 can be programmed to turn the pages of a book forward or backward using the right and left buttons respectively. This behavior can be altered for other countries, such as, for example, Japan and China where books are read from right to left. Additionally, the up button 204 can be used to go to the home screen and the track pad 210 can be used to scroll through the available items shown. As can be appreciated there are many variations of control combinations that can be assigned to the remote control 102. The examples given herein are not meant to be limiting, only demonstrative.

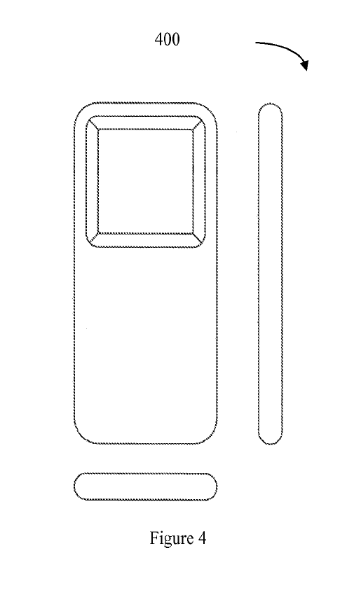

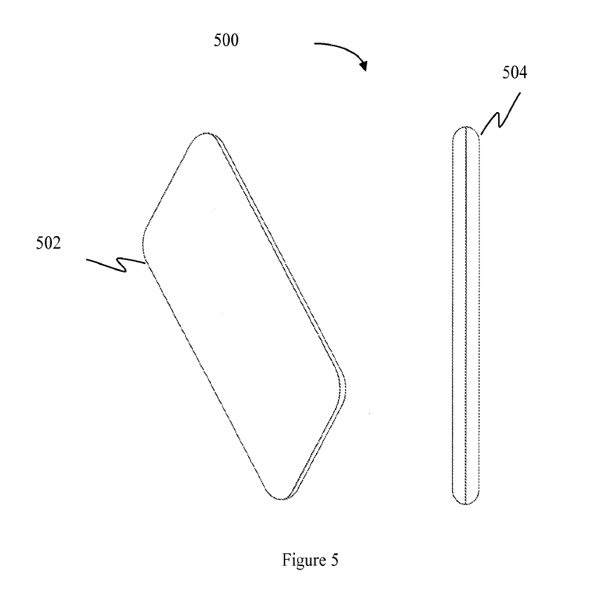

Referring now to FIG. 3, there is shown a diagram depicting a bottom view 300 of the remote control 102 of FIG. 1. As can be seen, the remote control 102, in this embodiment, is slim and unobtrusive to the user.

Referring now to FIG. 4, there is shown a diagram 400 depicting a side view of the remote control 102 of FIG. 1.

Referring now to FIG. 5, there is shown a diagram 500 depicting an oblique 502 and side view 504 of the remote control 102 of FIG. 1.

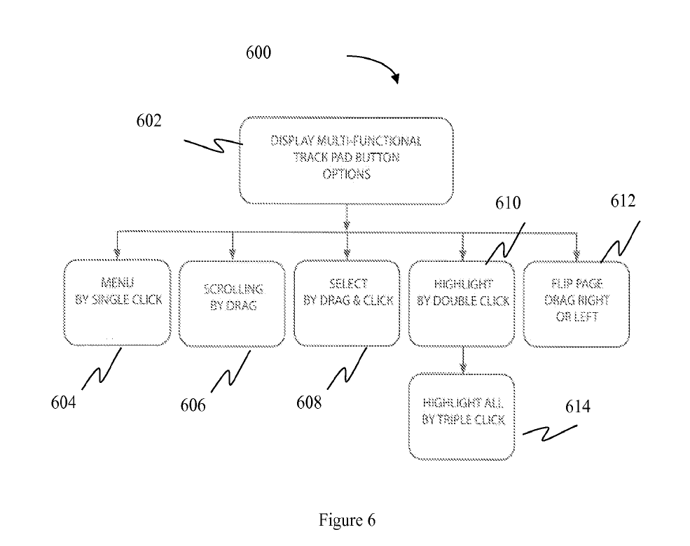

Referring now to FIG. 6, there is shown a functional diagram for using the remote control 102 of FIG. 1. As shown, the track pad 210 can be assigned various functions to perform. The track pad 210 can be operated to select a menu item by pressing down on the track pad. Also, the track pad 210 can function as a replacement for a user's finger for scrolling, selecting, or dragging on the portable electronic device 104. Additionally, the user can highlight a selection 610 by double clicking (depressing the track pad twice) or selecting/highlighting everything by triple clicking 614 on the track pad. Moreover, the user can flip back and forth between pages 612 by swiping a finger over the track pad 210 in left to right and right to left motions. Other motions for operating the portable electronic device 104 are well documented in the prior art and can be implemented using the remote control 102 and associated software.

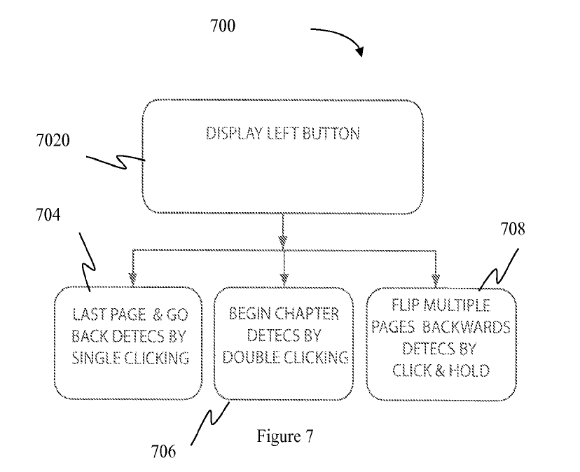

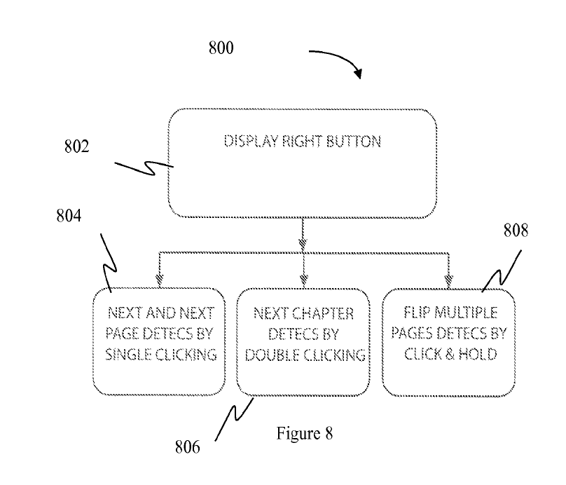

Referring now to FIG. 7, there is shown a functional diagram 700 for using a left button 202 of the remote control 102 of FIG. 1. As can be seen the left button 202 can also have a variety of functionality. For example, an display 702 of the left button on the device 104, last page and go back detects by single clicking 704, begin chapter detects by double clicking 706; and flip multiple pages backwards detects by click and hold 706.

Referring now to FIG. 8, there is shown a functional diagram 800 for using a right button 206 of the remote control 102 of FIG. 1. As can be seen the right button 206 can also have a variety of functionality, such as, for example: volume down detects by single clicking, and zoom out detects by double clicking.

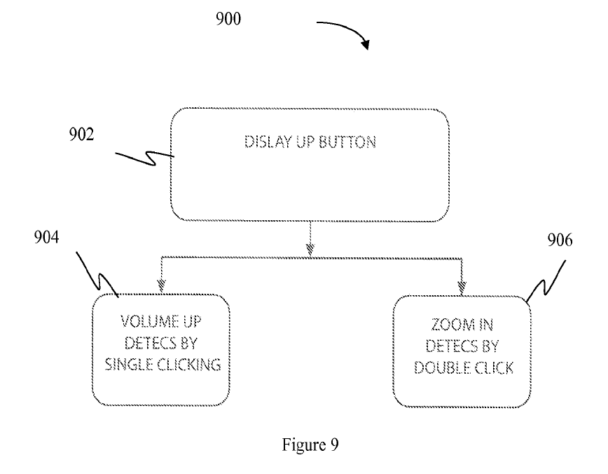

FIG. 9 is functional diagram 900 for using an up button 204 of the remote control 102 of FIG. 1. As can be seen, the up button 204 can also have a variety of functionality. For example, the up button 204 can increase the volume by a single click 902 or zoom in detects by double clicking 904.

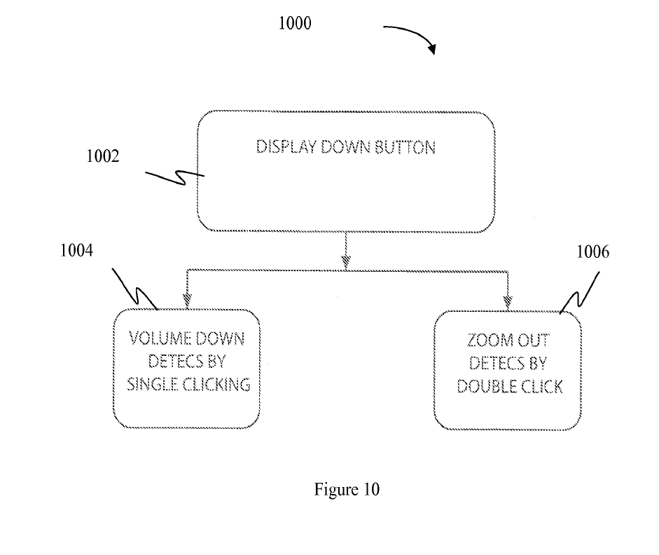

FIG. 10 is a functional diagram 1000 for using a down button 206 of the remote control 102 of FIG. 1. As can be seen, the down button 206 can also have a variety of functionality. For example, the down button can decrease the volume by a single click 1002 or provide a zoom out functionality 1004 by a double click.

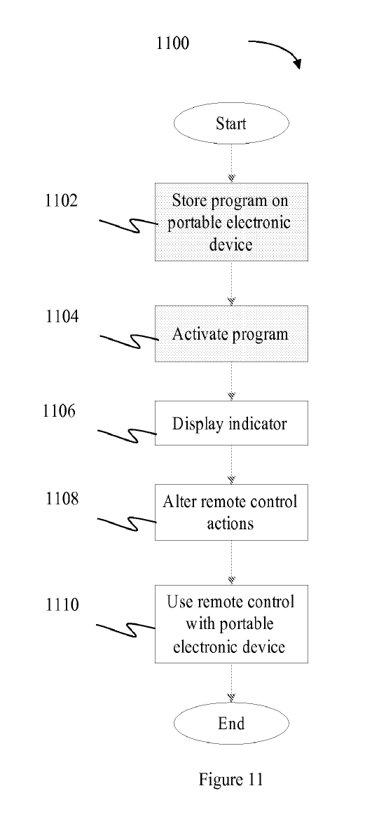

Referring now to FIG. 11, there is shown a flowchart diagram for using the remote control 102 of FIG. 1. First, a software program 1102 is stored in a storage on the portable electronic device 104. Then, the user activates 1104 the program. Optionally, the program can be activated 1104 by the remote control 102, or the program 1102 can be activated 1104 when the remote control 102 is connected to the portable electronic device 104. Also optionally, an indicator on the portable electronic device 104 is displayed 1106 providing the user with confirmation that the system 100 is operational and ready for use. Optionally, the user can alter the actions 1108 that each control on the remote control 102 performs. Next, the user can manipulate 1110 the portable electronic device 104 using the remote control 102.

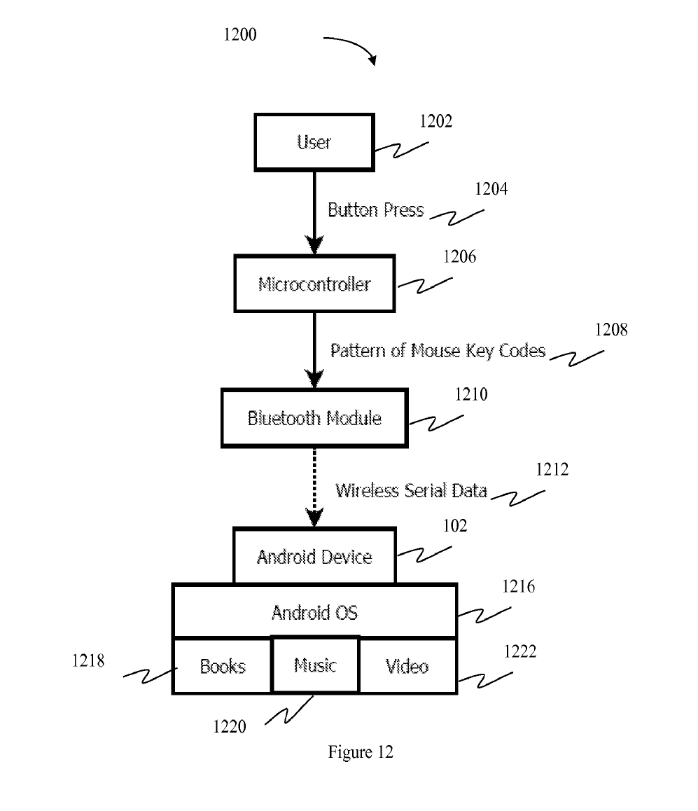

Referring now to FIG. 12, there is shown a flowchart 1200 of some steps of a method for mouse emulation media mode according to one embodiment. As can be seen, a user first presses a button 1202. Then, a microcontroller 1206 receives a notification of the button press 1204 by the user of the remote 102. Next, instructions operable on the microcontroller 1206 convert the received notification of the button press 1204 by the user into a pattern of mouse key codes 1208. Then, the microcontroller 1206 instructs a Bluetooth module 12102 transmits the pattern of mouse key codes 1208 either wired or wirelessly as serial data 1212 to the portable electronic device 104. The operating system 1216 of the portable electronic device 104, such as, for example, android OS® then comprises instructions to use the pattern of mouse key codes 1208 for applications 1218, 1220, 1222 operable on the portable electronic device 104. For example, the applications 1218-1222 can be selected from the group consisting of books, music and video among others.

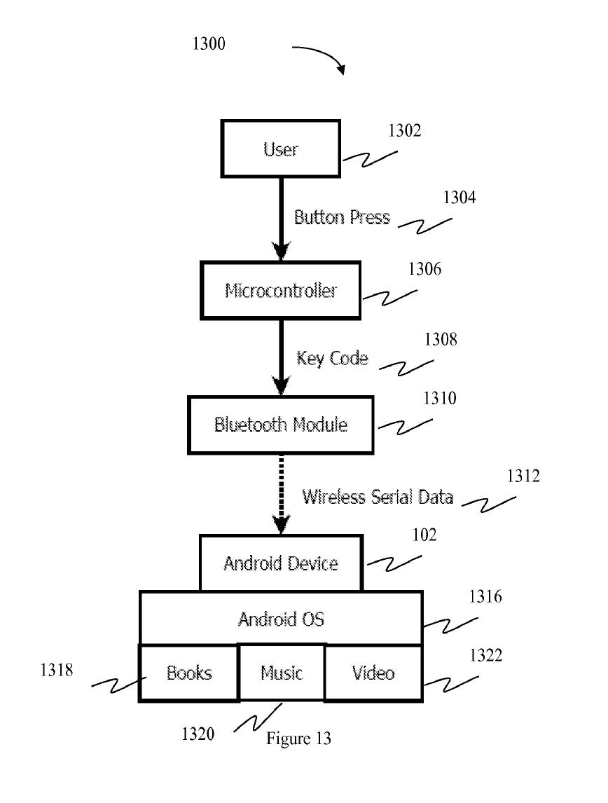

Referring now to FIG. 13, there is shown a flowchart 1300 of some steps of a method for simple keyboard control according to one embodiment. As can be seen a user 1302 presses a button 1304 on the remote 102. A microcontroller 1306 embedded in the remote 102 comprises instructions for converting the button press 1304 into a key code 1308. Once the microcontroller 1206 has converted the key code 1308, the key code 1308 is then sent to a Bluetooth module 1310 to be transmitted as wireless serial data 1312 to a portable electronic device 102. Once the wireless serial data 1312 has been received by the portable electronic device 102 and operating system 1316 comprises instructions for interpreting the wireless serial data 1312. The wireless serial data 1312 can be used to control various applications 1318, 1320 and 1322 operable on the portable electronic device 102. For example, the wireless serial data 1312 can be used to operate a book application 1318 for turning pages, activating multimedia such as music 1320 or videos 1322. Although these are common applications, the uses for the remote go beyond just the typical applications described herein. Because the remote 102 can be programmed for a variety of functions, it can be programmed to operate multiple applications at once for singular and applications with an increased functionality only previously capable by direct user interaction on the portable electronic device 104. Therefore the descriptions given herein are not meant to be limiting as to the applications they can be controlled but to demonstrate how the remote 102 can transmit any codes necessary to operate the application from a distance without requiring direct user intervention on the device. As can be appreciated, a programmable remote 102 for use on portable electronic devices 104 can have a great impact upon the use of the portable electronic device 104.

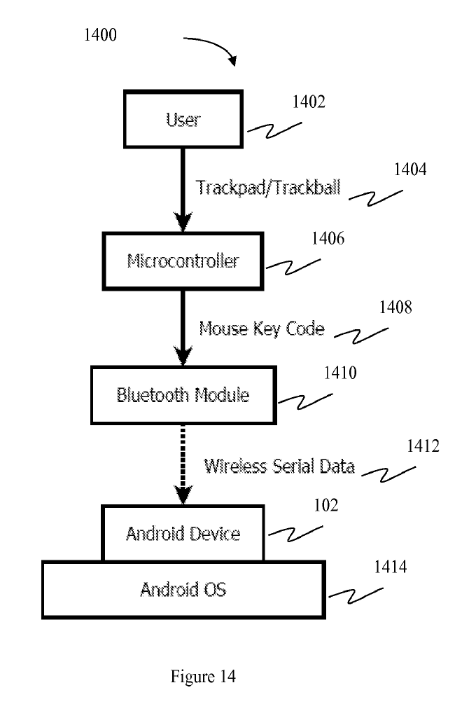

Referring now to FIG. 14, there is shown a flowchart 1400 of some steps of a method for mouse cursor control according to one embodiment. As can be seen, a user 1402 can use the track pad 210 on the remote 102 to send track pad commands 1404 to a microcontroller 1406. Optionally, the track pad 210 could in fact be any other type of pointing device such as, for example, a joystick, a trackball or another biometric device. The motion of the user's 1402 finger across the track pad 210 transmits position related data to the microcontroller 1406. The microcontroller comprises instructions operable for converting the track pad position data 1404 into mouse key codes 1408. Once the microcontroller 1406 has converted the track pad position data 1404 into mouse key codes 1408, the mouse key codes 1408 are transmitted via a Bluetooth module 1410 as wireless serial data 1412 to a portable electronic device 102. When received by the portable electronic device 102 the operating system 1416 comprises instructions for moving a cursor across the screen of the portable electronic device 102. The motion of the cursor across the screen of the portable electronic device 102 is relative to the user's 1402 finger motion across the track pad 1404.

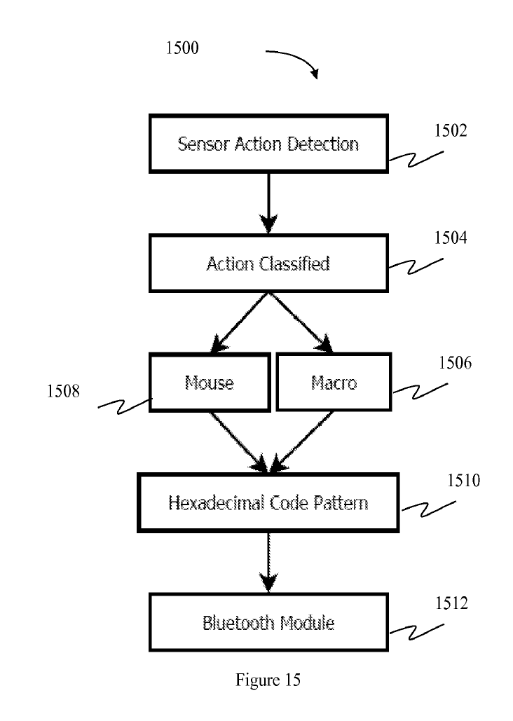

Referring now to FIG. 15, there is shown a flowchart 1500 of some steps of a method for microcontroller software according to one embodiment. In this embodiment, motion of the remote 102 is used to control the portable electronic device 104. First, a motion sensor action 1502 is detected. Then, the action 1502 is classified 1504 as either a macro action 1506 or a mouse action 1508. Next, a hexadecimal code pattern is generated 1510 to match the classified action 1504. Then, the generated hexadecimal code pattern 1510 is transmitted to a Bluetooth module 1512 to be retransmitted to the portable electronic device 104. As will be understood by those with skill in the art with reference to this disclosure, the portable electronic device 104 comprises instructions forming an operating system that can receive the transmissions from the Bluetooth module 1512 and act upon receipt of the hexadecimal code pattern 1510 according to any running applications, or the operating system itself.

What has been described is a new and improved system and method for a remote control 102 for portable electronic devices 104 that is simple operate and operable with a single hand, overcoming the limitations and disadvantages inherent in the related art.

Although the present invention has been described with a degree of particularity, it is understood that the present disclosure has been made by way of example. As various changes could be made in the above description without departing from the scope of the invention, it is intended that all matter contained in the above description or shown in the accompanying drawings shall be illustrative and not used in a limiting sense.

What is claimed is:

1. A system for remote control of a portable electronic device comprising:
a) one or more than one remote control;
b) one or more than one portable electronic device operably connected to the remote control;
c) one or more than one microcontroller connected to the one or more than one remote control; and
d) computer instructions operable on the microcontroller stored on a storage connected to the remote control for manipulating the portable electronic device.

2. The system of claim 1, where the one or more than one remote control is connected to the one or more than one portable electronic device wirelessly, wired or both wirelessly and wire.

3. A remote control device comprising:
a) a body;
b) one or more than one button affixed to the body;
c) one or more than one control mechanism affixed to the body;
d) one or more than one microcontroller disposed within the body;
e) one or more than one communications controller disposed within the body; and
f) a battery to power the remote control is disposed within the body and electrically connected to the one or more than one button, the one or more than one control mechanism, the one or more than one microcontroller and the one or more than one communications controller.

4. The remote control of claim 3, where the one or more than one button are an up button, a down button, a left button and right button 206.

5. The remote control of claim 3, where the one or more than one control mechanism is selected from the group consisting of a track pad, a trackball and a joystick.

6. The remote control of claim 3, where the one or more than one control mechanism is a track pad.

7. The remote control of claim 3, where the one or more than one microcontroller further comprises a storage operably connected to the one or more than one microcontroller.

8. The remote control of claim 7, where the storage comprises computer instructions operable to enable the remote control to manipulate various functions on the portable electronic device.

9. The remote control of claim 8, where the instructions provide for mouse like emulation to control various other applications on the portable electronic device.

10. A method for using a remote control device, the method comprising the steps of:
a) storing a software program in a storage on the portable electronic device;
b) activating the software program; and
c) manipulating the portable electronic device using the remote control and instructions from the software program.

11. The method of claim 10, where the software program can be activated by the remote control.

12. The method of claim 10, where the software program can be activated when the remote control is connected by a wire to the portable electronic device.

13. The method of claim 10 further comprising the step of displaying an indicator on the portable electronic device providing the user with confirmation that the system is operational and ready for use.

14. The method of claim 10 further comprising the step of altering the actions that each control on the remote control performs.

15. The method of claim 10, where the instructions for the software program comprise:
a) selecting a menu item by pressing down on a track pad;
b) scrolling on the portable electronic device;
c) dragging on the portable electronic device;
d) highlighting a selection by double clicking the track pad;
e) selecting, highlighting or both selecting and highlighting everything on the portable remote device by triple clicking on the track pad; and
flipping back and forth between pages by swiping a finger over the track pad in left to right and right to left motions.

16. The method of claim 15, where a left button of the remote can activate instructions on the microcontroller to provide functions selected from the group consisting of jumping to a last page, go back detects, begin chapter detects, and flip multiple pages backwards detects.

17. The method of claim 15, where a right button of the remote can activate instructions on the microcontroller to provide functions selected from the group consisting of volume down detects and zoom out detects.

18. The method of claim 15, where an up button of the remote can activate instructions on the microcontroller to provide functions selected from the group consisting of increasing the volume and zoom in detects.

19. The method of claim 15, where a down button of the remote can activate instructions on the microcontroller to provide functions selected from the group consisting of decreasing the volume and a zoom out functionality.

20. The method of claim 10, further comprising instructions for mouse emulation media; where:
a) the instructions operable on the microcontroller convert the received notification of a button press by the user into a pattern of mouse key codes; and
b) the microcontroller instructs a Bluetooth module to transmit the pattern of mouse key codes either wired or wirelessly as serial data to the portable electronic device.

21. The method of claim 10, further comprises instructions for keyboard control; the instructions for:
a) converting a button press into a key code;
b) sending the key code to a Bluetooth module; and
c) transmitting the key code as wireless serial data to a portable electronic device.

22. The method of claim 10, further comprises instructions for mouse cursor control; the instructions for:
a) sending track pad commands to a microcontroller;
b) converting the track pad commands into mouse key code; and
c) transmitting the mouse key codes via a Bluetooth module as wireless serial data to a portable electronic device.

23. The method of claim 10, further comprises instructions for mouse cursor control; the instructions for:
a) transmitting track pad position related data to the microcontroller;
b) converting the track pad position data into mouse key codes; and
c) transmitting the mouse key codes via a Bluetooth module as wireless serial data to a portable electronic device; where the motion of the cursor across the screen of the portable electronic device is relative to the motion across the track pad.

24. A method for microcontroller software to control a portable electronic device, the method comprising the steps of:
a) detecting a motion sensor action;
b) classifying the motion sensor action;
c) generating a hexadecimal code pattern to match the classified action; and
d) transmitting the generated hexadecimal code pattern to a Bluetooth module to be retransmitted to a portable electronic device.

25. The method of claim 24, where the motion sensor action can be classified as a macro action, a mouse action or both a macro action and a mouse action.
